(19) United States
(12) Patent Application Publication
(10) Pub. No.: US 2009/0326815 A1
(43) Pub. Date: Dec. 31, 2009

(54) Position Fix Indicator

(75) Inventors: Richard Williamson, Los Gatos, CA (US); Mike Matas, San Francisco, CA (US); Christopher Blumenberg, San Francisco, CA (US); Kimon Tsinteris, Hillsborough, CA (US)

Correspondence Address: FISH & RICHARDSON P.C., PO BOX 1022, MINNEAPOLIS, MN, 55440-1022, US

(73) Assignee: Apple Inc., Cupertino, CA (US)

(21) Appl. No.: 12/114,714

(22) Filed: May 2, 2008

(51) Int. Cl. G01C 21/00

(52) U.S. Cl. 701/212; 701/208

(57) ABSTRACT

Methods, systems, and apparatus, including computer program products, for presenting location information. In some implementations, a method includes: obtaining a first position measure at a mobile device indicating a geographic area where the mobile device is located, presenting a first graphical indicator on a user interface representing the geographic area; obtaining a second position measure at the mobile device, indicating a location associated with the mobile device, and within the geographic area; and presenting a second graphical indicator on the user interface representing the location within the geographic area.

### TECHNICAL FIELD

This disclosure relates to graphical user interfaces.

### BACKGROUND

The role of traditional printed maps is being supplanted by modern devices capable of rendering dynamic map displays. Devices that include mapping or navigation applications provide information regarding an area selected by a user by recalling map data from local memory or networked services.

When coupled with any of a number of positioning technologies, a mapping device can display a current position on a map as well as deliver navigation instructions based on the current position to route a user to a desired destination. Positioning technologies include satellite based positioning systems, such as the Global Positioning System (GPS), cell tower triangulation, and network-based positioning systems (e.g., Wi-Fi positioning system). Positioning technologies provide varying degrees of accuracy or precision. For example, GPS is generally accurate to a few meters, while other positioning technologies are generally less accurate.

### SUMMARY

In general, one aspect of the subject matter described in this specification can be embodied in methods that include the actions of obtaining a first position measure at a mobile device indicating a geographic area where the mobile device is located, presenting a first graphical indicator on a user interface representing the geographic area; obtaining a second position measure at the mobile device, indicating a location associated with the mobile device, and within the geographic area; and presenting a second graphical indicator (e.g., an updated first graphical indicator) on the user interface representing the location within the geographic area. Other embodiments of this aspect include corresponding systems, apparatus, computer program products, and computer readable media.

The disclosed implementations can be applied to two or more position measures each having its own graphical indicator. In some implementations, audio and/or force feedback indicators can be used with a graphical indicator, or in place of a graphical indicator, for representing a geographic area or mobile device location on a user interface.

Particular embodiments of the subject matter described in this specification can be implemented to realize one or more of the following advantages. Users are informed graphically and audibly when location information is being determined or has been determined. Different visual and audio indicators are presented to signify an ongoing location determination or an actual location determination. Thus, different visual and/or audio indicators prevent users from questioning whether a location determination is currently being or has been performed.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example mobile device.

FIG. 2 is a block diagram of an example network operating environment for the mobile device of FIG. 1.

FIG. 3 is a block diagram of an example implementation of the mobile device of FIG. 1.

FIG. 4 illustrates an example implementation of a navigation system.

FIG. 5A illustrates an example of a map with a geographic area displayed on the mobile device of FIG. 1.

FIG. 5B illustrates another example of the map from FIG. 5A.

FIG. 6 illustrates a zoomed out view of the map from FIG. 5A.

FIG. 7 illustrates another view of the map from FIG. 5A.

FIG. 8 illustrates another view of the map from FIG. 5A with a larger geographic area than shown in FIG. 6.

FIG. 9 illustrates a flow diagram of an example process for indicating a location within a geographic area.

FIG. 10 illustrates another view of the map from FIG. 6 with a geographic area including animated location indicator.

FIG. 11 illustrates another view of the map from FIG. 5A with a geographic area including a non-animated location indicator.

Like reference numbers and designations in the various drawings indicate like elements.

### DETAILED DESCRIPTION

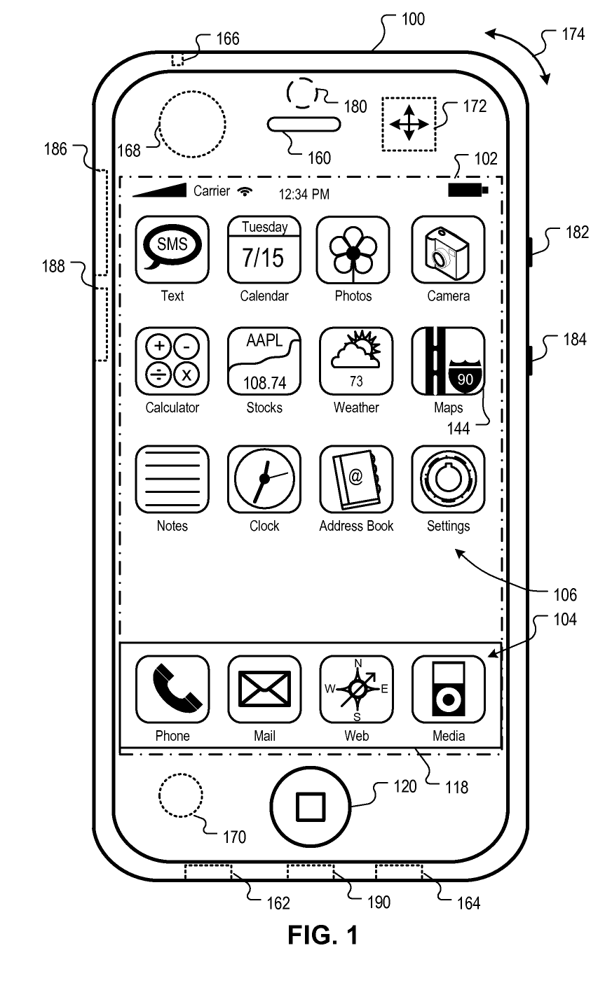

FIG. 1 is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

### Mobile Device Overview

In some implementations, the mobile device 100 includes a touch-sensitive display 102. The touch-sensitive display 102 can implement liquid crystal display (LCD) technology, light emitting polymer display (LPD) technology, or some other display technology. The touch sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used (e.g., a display in which contact is made using a stylus or other pointing device). Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 100 can display one or more graphical user interfaces on the touch-sensitive display 102 for providing the user access to various system objects and for conveying information to the user. In some implementations, the graphical user interface can include one or more display objects 104, 106. In the example shown, the display objects 104, 106, are graphic representations of system objects. Some examples of system objects include device functions, applications, windows, files, alerts, events, or other identifiable system objects.

### Example Mobile Device Functionality

In some implementations, the mobile device 100 can implement multiple device functionalities, such as a telephony device, an e-mail device, a network data communication device, a Wi-Fi base station device (not shown), and a media processing device. In some implementations, particular display objects 104 can be displayed in a menu bar 118. In some implementations, device functionalities can be accessed from a top-level graphical user interface, such as the graphical user interface illustrated in FIG. 1. Touching one of the objects 104 can, for example, invoke a corresponding functionality.

In some implementations, the mobile device 100 can implement network distribution functionality. For example, the functionality can enable the user to take the mobile device 100 and provide access to its associated network while traveling. In particular, the mobile device 100 can extend Internet access (e.g., Wi-Fi) to other wireless devices in the vicinity. For example, mobile device 100 can be configured as a base station for one or more devices. As such, mobile device 100 can grant or deny network access to other wireless devices.

In some implementations, upon invocation of device functionality, the graphical user interface of the mobile device 100 changes, or is augmented or replaced with another user interface or user interface elements, to facilitate user access to particular functions associated with the corresponding device functionality. For example, in response to a user touching a phone object, the graphical user interface of the touch-sensitive display 102 may present display objects related to various phone functions. Similarly, touching of an email object may cause the graphical user interface to present display objects related to various e-mail functions, touching a Web object may cause the graphical user interface to present display objects related to various Web-surfing functions, and touching a media player object may cause the graphical user interface to present display objects related to various media processing functions.

In some implementations, the top-level graphical user interface environment or state of FIG. 1 can be restored by pressing a button 120 located near the bottom of the mobile device 100. In some implementations, each corresponding device functionality may have corresponding “home” display objects displayed on the touch-sensitive display 102, and the graphical user interface environment of FIG. 1 can be restored by pressing the “home” display object.

In some implementations, the top-level graphical user interface can include additional display objects 106, such as a short messaging service (SMS) object, a calendar object, a photos object, a camera object, a calculator object, a stocks object, a weather object, a maps object 144, a notes object, a clock object, an address book object, and a settings object. Touching the maps object 144 can, for example, invoke a mapping and location-based services environment and supporting functionality. Likewise, a selection of any of the display objects 106 can invoke a corresponding object environment and functionality.

Additional and/or different display objects can also be displayed in the graphical user interface of FIG. 1. For example, if the device 100 is functioning as a base station for other devices, one or more “connection” objects may appear in the graphical user interface to indicate the connection. In some implementations, the display objects 106 can be configured by a user (e.g., a user may specify which display objects 106 are displayed). In some implementations, a user can download additional applications or other software that provides other functionalities. In those implementations, display objects (e.g., new display objects or display objects corresponding to the downloaded functionalities), can also be downloaded (e.g., if they don't already exist on the device 100).

In some implementations, the mobile device 100 can include one or more input/output (I/O) devices and/or sensor devices. For example, a speaker 160 and a microphone 162 can be included to facilitate voice-enabled functionalities, such as phone and voice mail functions. In some implementations, an up/down button 184 for volume control of the speaker 160 and the microphone 162 can be included. The mobile device 100 can also include an on/off button 182 for a ring indicator of incoming phone calls. In some implementations, a loud speaker 164 can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the mobile device 100 proximate to the user's ear. In those implementations, when the user has positioned the device 100 within a predetermined distance of the user's ear, the touch-sensitive display 102 can be disengaged (e.g., to prevent accidental function invocations). In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the mobile device 100, as indicated by the directional arrow 174. Accordingly, display objects and/or media can be presented according to a detected orientation (e.g., portrait or landscape). In some implementations, the mobile device 100 may include circuitry and sensors for supporting a location determining capability, such as that provided by the Global Positioning System (GPS) or other positioning systems (e.g., systems using Wi-Fi access points, television signals, cellular grids, Uniform Resource Locators (URLs)). In some implementations, a positioning system (e.g., a GPS receiver), can be integrated into the mobile device 100 or provided as a separate device that can be coupled to the mobile device 100 through an interface (e.g., port device 190), to provide access to location-based services.

In some implementations, a port device 190 (e.g., a Universal Serial Bus (USB) port, or a docking port, or some other wired port connection), can be included. The port device 190 can, for example, be used to establish a wired connection to other computing devices, such as other communication devices 100, network access devices, a personal computer, a printer, a display screen, or other processing devices capable of receiving and/or transmitting data. In some implementations, the port device 190 allows the mobile device 100 to synchronize with a host device using one or more protocols (e.g., TCP/IP, HTTP, UDP, or any other known protocol).

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as an 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

### Network Operating Environment

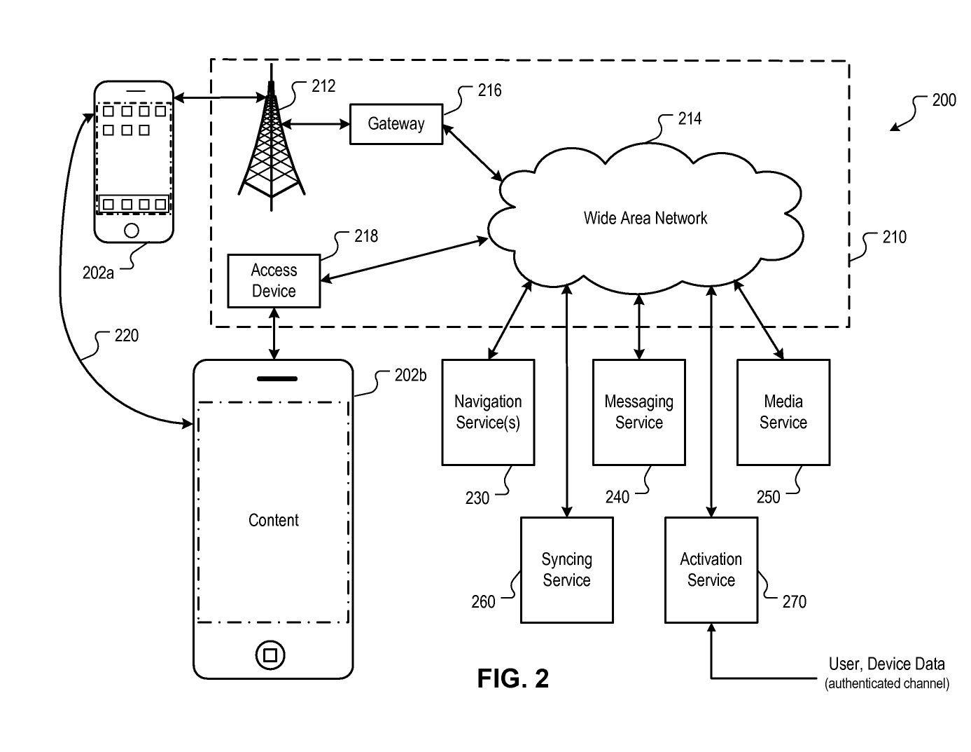

FIG. 2 is a block diagram of an example network operating environment 200. In FIG. 2, mobile devices 202a and 202b each can represent mobile device 100. Mobile devices 202a and 202b can, for example, communicate over one or more wired and/or wireless networks 210 in data communication. For example, a wireless network 212 (e.g., a cellular network), can communicate with a wide area network (WAN) 214, such as the Internet, by use of a gateway 216. Likewise, an access device 218, such as an 802.11g wireless access device, can provide communication access to the wide area network 214. In some implementations, both voice and data communications can be established over the wireless network 212 and the access device 218. For example, the mobile device 202a can place and receive phone calls (e.g., using VoIP protocols), send and receive e-mail messages (e.g., using POP3 protocol), and retrieve electronic documents and/or streams, such as web pages, photographs, and videos, over the wireless network 212, gateway 216, and wide area network 214 (e.g., using TCP/IP or UDP protocols).

Likewise, in some implementations, the mobile device 202b can place and receive phone calls, send and receive e-mail messages, and retrieve electronic documents over the access device 218 and the wide area network 214. In some implementations, the mobile device 202a or 202b can be physically connected to the access device 218 using one or more cables and the access device 218 can be a personal computer. In this configuration, the mobile device 202a or 202b can be referred to as a “tethered” device.

The mobile devices 202a and 202b can also establish communications by other means. For example, the wireless device 202a can communicate with other wireless devices (e.g., other mobile devices 202a or 202b, cell phones, etc.), over the wireless network 212. Additionally, the mobile devices 202a and 202b can establish peer-to-peer communications 220 (e.g., a personal area network), by use of one or more communication subsystems, such as the Bluetooth™ communication devices 188 shown in FIG. 1. Other communication protocols and topologies can also be implemented.

The mobile device 202a or 202b can, for example, communicate with one or more services 230, 240, 250, 260, and 270 over the one or more wired and/or wireless networks 210. For example, one or more navigation services 230 can provide navigation information (e.g., map information, location information, route information, and other information), to the mobile device 202a or 202b. A user of the mobile device 202b can invoke a map functionality (e.g., by pressing the maps object 144 on the top-level graphical user interface shown in FIG. 1). For example, once the user has invoked the map functionality, the user can request and receive a map for a particular location, request and receive route directions, or request and receive listings of businesses in the vicinity of a particular location.

A messaging service 240 can, for example, provide e-mail and/or other messaging services. A media service 250 can, for example, provide access to media files, such as song files, audio books, movie files, video clips, and other media data. In some implementations, separate audio and video services (not shown) can provide access to the respective types of media files. A syncing service 260 can, for example, perform syncing services (e.g., sync files). An activation service 270 can, for example, perform an activation process for activating the mobile device 202a or 202b.

Other services can also be provided, including a software update service that automatically determines whether software updates exist for software on the mobile device 202a or 202b. When a software update exists, the software update service can download the software update to the mobile device 202a or 202b where the software update can be manually or automatically unpacked and/or installed.

The mobile device 202a or 202b can also access other data and content over the one or more wired and/or wireless networks 210. For example, content publishers, such as news sites, RSS feeds, web sites, blogs, social networking sites, developer networks, etc., can be accessed by the mobile device 202a or 202b. Such access can be provided by invocation of a web browsing function or application (e.g., a browser), in response to a user touching, for example, a Web object.

### Example Mobile Device Architecture

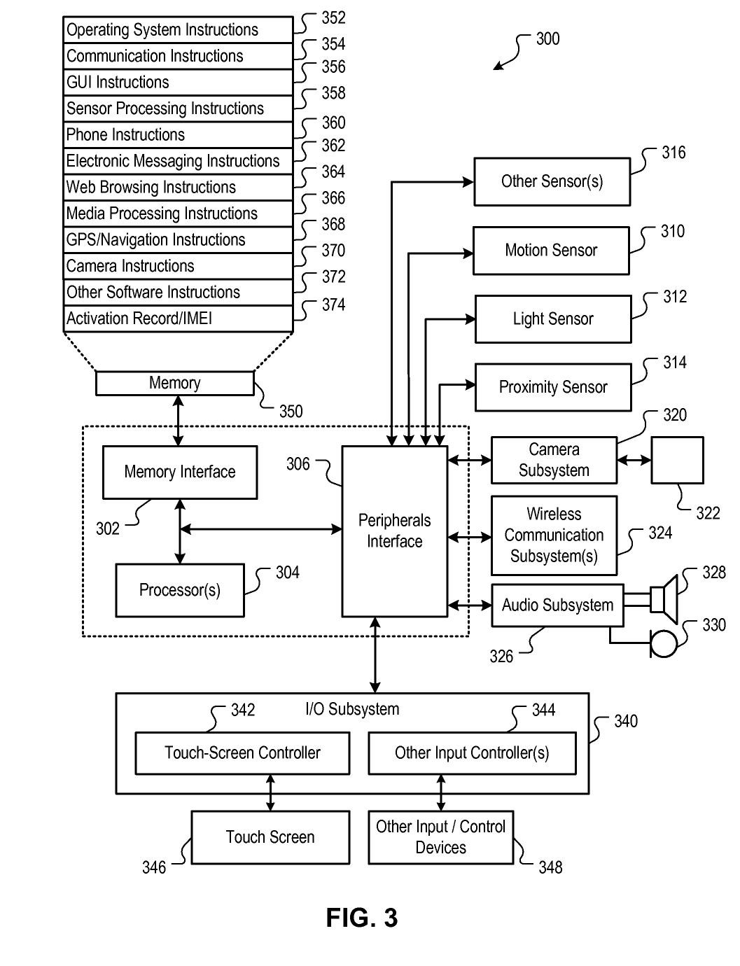

FIG. 3 is a block diagram 300 of an example implementation of the mobile device 100 of FIG. 1. The mobile device 100 can include a memory interface 302, one or more data processors, image processors and/or central processing units 304, and a peripherals interface 306. The memory interface 302, the one or more processors 304 and/or the peripherals interface 306 can be separate components or can be integrated in one or more integrated circuits. The various components in the mobile device 100 can be coupled by one or more communication buses or signal lines.

Sensors, devices, and subsystems can be coupled to the peripherals interface 306 to facilitate multiple functionalities. For example, a motion sensor 310, a light sensor 312, and a proximity sensor 314 can be coupled to the peripherals interface 306 to facilitate the orientation, lighting, and proximity functions described with respect to FIG. 1. Other sensors 316 can also be connected to the peripherals interface 306, such as a positioning system (e.g., GPS receiver), a temperature sensor, a biometric sensor, or other sensing device, to facilitate related functionalities.

A camera subsystem 320 and an optical sensor 322 (e.g., a charged coupled device (CCD) or a complementary metal-oxide semiconductor (CMOS) optical sensor), can be utilized to facilitate camera functions (e.g., recording photographs and video clips).

Communication functions can be facilitated through one or more wireless communication subsystems 324, which can include radio frequency receivers and transmitters and/or optical (e.g., infrared) receivers and transmitters. The specific design and implementation of the communication subsystem 324 can depend on the communication network(s) over which the mobile device 100 is intended to operate.

For example, a mobile device 100 may include communication subsystems 324 designed to operate over a GSM network, a GPRS network, an EDGE network, a Wi-Fi or WiMax network, and a Bluetooth™ network, using an analog cellular phone data channel, a dialup cellular connection, a Short Message Service (SMS) message, a satellite communication link, or a local analog or digital radio system. In particular, the wireless communication subsystems 324 may include hosting protocols such that the device 100 may be configured as a base station for other wireless devices.

An audio subsystem 326 can be coupled to a speaker 328 and a microphone 330 to facilitate voice-enabled functions, such as voice recognition, voice replication, digital recording, and telephony functions.

The I/O subsystem 340 can include a touch screen controller 342 and/or other input controller(s) 344. The touch-screen controller 342 can be coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346.

The other input controller(s) 344 can be coupled to other input/control devices 348, such as one or more buttons, rocker switches, thumb-wheel, infrared port, USB port, and/or a pointer device such as a stylus. The one or more buttons (not shown) can include an up/down button for volume control of the speaker 328 and/or the microphone 330.

In one implementation, a pressing of the button for a first duration may disengage a lock of the touch screen 346 and a pressing of the button for a second duration that is longer than the first duration may turn power to the mobile device 100 on or off. In some implementations, the user can customize a functionality of one or more of the buttons. In other implementations, the touch screen 346 can also be used to implement virtual or soft buttons and/or a keyboard.

In some implementations, the mobile device 100 can present recorded audio and/or video files, such as MP3, AAC, and MPEG files. In some implementations, the mobile device 100 can include the functionality of an MP3 player, such as an iPod™. The mobile device 100 may, therefore, include a 36-pin connector that is compatible with the iPod™. Other input/output and control devices can also be used.

The memory interface 302 can be coupled to memory 350. The memory 350 can include high-speed random access memory and/or non-volatile memory, such as one or more magnetic disk storage devices, one or more optical storage devices, and/or flash memory (e.g., NAND, NOR). The memory 350 can store an operating system 352, such as Darwin, RTXC, LINUX, UNIX, OS X, WINDOWS®, or an embedded operating system such as VxWorks. The operating system 352 may include instructions for handling basic system services and for performing hardware dependent tasks. In some implementations, the operating system 352 can be a kernel (e.g., UNIX kernel).

The memory 350 may also store communication instructions 354 to facilitate communicating with one or more additional devices, one or more computers and/or one or more servers. The memory 350 may include graphical user interface instructions 356 to facilitate graphic user interface processing; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/Navigation instructions 368 to facilitate GPS and navigation-related processes and instructions; camera instructions 370 to facilitate camera-related processes and functions; and/or other software instructions 372 to facilitate other processes and functions (e.g., security processes and functions).

The memory 350 may also store other software instructions (not shown), such as web video instructions to facilitate web video-related processes and functions; and/or web shopping instructions to facilitate web shopping-related processes and functions. In some implementations, the media processing instructions 366 are divided into audio processing instructions and video processing instructions to facilitate audio processing-related processes and functions and video processing-related processes and functions, respectively. An activation record and International Mobile Equipment Identity (IMEI) 374 or similar hardware identifier can also be stored in memory 350.

Each of the above identified instructions and applications can correspond to a set of instructions for performing one or more functions described above. These instructions need not be implemented as separate software programs, procedures, or modules. The memory 350 can include additional instructions or fewer instructions. Furthermore, various functions of the mobile device 100 may be implemented in hardware and/or in software, including in one or more signal processing and/or application specific integrated circuits.

### Example Navigation System

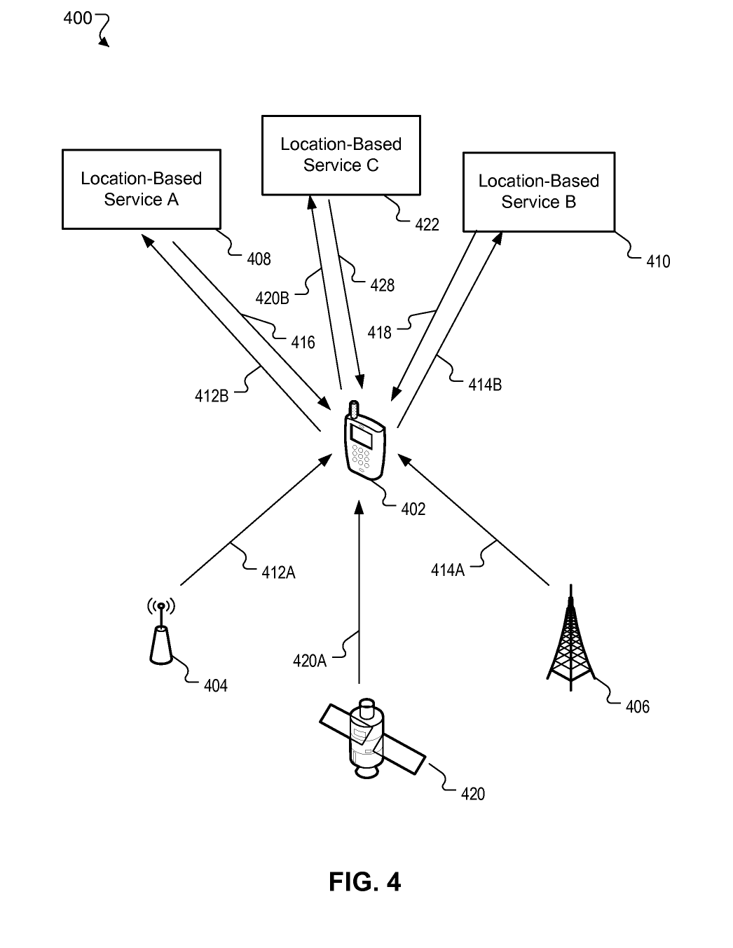

FIG. 4 illustrates an example implementation of a navigation system 400. In some implementations, mobile device 402 can represent mobile device 100 of FIG. 1. The mobile device 402 can, for example, communicate to one or more network access points 404 (e.g., Wi-Fi base station devices), one or more cell towers 406, or multiple GPS satellites 420. In some implementations, the access points 404, can be any combination of 802.11b/g wireless routers, 802.11n wireless routers, and some other Wi-Fi devices that implement any suitable Wi-Fi or other wireless networking technology or protocol. Using the communication with the access points 404, the cell towers 406, or the GPS satellites 420, a location-based service 408 (Location-Based Service A), a location-based service 410 (Location-Based Service B), or a location-based service 422 (Location-Based Service C), can estimate geographic areas where the mobile device 402 is currently located. The actual location of the mobile device 402 can be anywhere within the estimated geographic area. An estimated geographic area is not necessarily circular but can be indicated as a circular area on a map display for convenience.

The mobile device 402 can, for example, receive a communication 412A from an access point 404 (e.g., a Wi-Fi access point). The communication 412A can include information about the access point 404 (e.g., the Internet Protocol (IP) address and/or the Media Access Control (MAC) address of the access point 404). The communication 412A can include other information, such as the latitude and longitude of the access point 404. The information received in communication 412A can be sent to location-based service A 408 in communication 412B. The location-based service A 408 can, for example, with a degree of uncertainty or error, estimate a first geographic area in which the mobile device 402 is currently located using the information sent in communication 412B.

In some implementations, the location-based service A 408 is a system or service that estimates, with some degree of uncertainty or error, the position of a device using a database of access points mapped to geographic locations. The accuracy or precision (or the degree of uncertainty or error) of the estimated position can, for example, be based on the range of the technology, the accuracy of the range, or some other metric. Accuracy or precision of an estimated position can be affected by one or more factors including, for example, inherent properties or limitations of the technology or system, and a level of deployment of the given technology or system (e.g., number of access points 404, cell towers 406, or GPS satellites 420 in the vicinity of the device).

In some implementations, the accuracy or precision of the estimated position is stated in units of distance (e.g., “the estimated position is accurate up to 50 meters”). That is, the actual position of the mobile device 402 can be within the accuracy distance from the estimated position. For example, the first geographic area can be a circle centered at the latitude and longitude of the estimated position with a radius equal to the stated accuracy or precision (e.g., 38 meters if the accuracy of the estimated position is up to 38 meters). The first geographic area can alternatively be represented on a map display as a square, rectangle, oval, diamond, triangle, or some other shaped enclosed region.

In other implementations, unique signatures of multiple access points (e.g., five or more), can be compared to a local cache on the mobile device 402 or a central reference database at location-based service A 408 using 1 network communication (e.g., communication 412B can be sent to the location-based service A 408). The location-based service 408 can use the unique signatures to estimate the latitude and longitude of the center of the first geographic circle with an m meter radius (e.g., about 20 meters).

In some implementations, location-based service A 408 includes positioning services and reference database information provided by SKYHOOK WIRELESS of Boston, Mass.

The mobile device 402 can receive a communication 414A from cell tower 406. The cell communication 414A can include, for example, information identifying the cell tower 406. In some implementations, the cell communication 414A can also include the latitude and longitude of the cell tower 406. The identifying information and/or the latitude and longitude of the cell tower 406 can be sent to the location-based service B 410 in communication 414B. The location-based service B 410 can estimate a position of the mobile device 402 using the information included in communication 414B and estimate an accuracy of the estimate position. Thus, for example, the location-based service B 410 can estimate a second geographic area in which the mobile device 402 is currently located. In some implementations, the second geographic area is represented on a map as a circular region centered at the estimated position and with a radius equal to the accuracy of the estimated position. In other implementations, the second geographic area can be represented on a map by a square or rectangular shaped enclosed region, for example.

In some implementations, the position and the geographic area of the mobile device 402 can be estimated using a “cell of origin” positioning technology. In some other implementations, the second geographic area can be determined by cell tower triangulation.

In some implementations, the mobile device 402 can determine or estimate its position and/or geographic area using other technologies (e.g., GPS). In some implementations, the geographic area determined or estimated using any of these other technologies can be used (e.g., displayed), in lieu of the geographic area estimated using location-based services 408 or 410 (e.g., Wi-Fi or cellular positioning techniques), if the geographic area determined or estimated using the other technologies is contained entirely within the geographic area estimated using location-based services 408 or 410 or if the other technologies are more accurate or precise according to the priority table stored in the mobile device 402.

Thus, in some implementations, the mobile device 402 can receive a communication 420A from multiple satellites 420. The communication 420A can include, for example, information identifying the multiple satellites 420. In some implementations, the cell communication 420A can also include the latitude and longitude of the multiple satellites 420. The identifying information and/or the latitude and longitude of the multiple satellites 420 can be sent to the location-based service C 422 in communication 420B. The location-based service C 422 can estimate a position of the mobile device 402 using the information included in communication 420B and estimate an accuracy of the estimated position.

Thus, for example, the location-based service C 422 can estimate a third geographic area in which the mobile device 402 is currently located. In some implementations, the third geographic area is represented on a map as a circular region centered at the estimated position and with a radius equal to the accuracy of the estimated position. In other implementations, the third geographic area can be represented on a map by a square or rectangular shaped enclosed region, for example.

The first, second and third geographic areas can be sent to the mobile device 402 by communications 416, 418, and 428, respectively. The mobile device 402 can present, on the touch-sensitive display 102 for example, a map view including an indication of one of the geographic areas if that one is entirely contained within the other geographic area (including the case where the boundaries of the geographic areas touch but otherwise no part of the one of the geographic area is outside of the other geographic area). For example, a map view that includes an indication of the first geographic area can be presented if the first geographic area is completely contained within the second geographic area.

The mobile device 402 can present a map view that includes an indication of the second geographic area if the first geographic area is not completely contained within the second geographic area. For example, if the technology, system, or service used to estimate the first geographic area has a greater level of accuracy or precision detail than the technology, system, or service used to estimate the second geographic area, and the first geographic area is determined to be more accurate or precise based on the first geographic area being entirely within the second geographic area, the mobile device 402 can use the first geographic area. The level of detail of the technology can, for example, be determined by a priority table stored in the mobile device 402.

In another example, the first geographic area can be estimated using the access point 404, the second geographic area can be estimated using the cell tower 406, and the third geographic area can be estimated using multiple satellites 420. For example, if an access point 404 is moved from its original location, the latitude and longitude coordinates of the access point 404 as they are known to location-based service A 408 would be incorrect, and the mobile device 402 would not actually located within the first geographic area. Thus, the cell tower 406 or the multiple satellites 420 can be used to provide correct location-based data when the mobile device 402 is located within the second and third geographic areas, respectively. Additionally, when the first, second, and third geographic areas do not overlap, the mobile device 402 can display a map view providing the correct location-based data (e.g., map data indicating the second or third geographic area).

The location-based service A 408, location-based service B 410, and location-based service C 422, can run on the same device or on separate devices. For example, the location-based services 408, 410, and 422, can run on servers communicating with the mobile device 100 through a network (e.g., WAN 214). The servers can be separate servers or the same server. The location-based services 408, 410, or 422, can alternatively run on the mobile device 402. The mobile device 402 or one or more external servers can be used to determine the accuracy of the first, second, and third geographic areas.

The mobile device 402 can, for example, connect to additional devices or services (not shown) for location-based services, instead of, or in addition to the access point 404, the cell tower 406, and multiple satellites 420. Such devices or services could include a Bluetooth™ device, GPS, radio or TV towers, or cellular grids, to name a few examples. For example, the mobile device 402 can connect to peer devices with the Bluetooth™ communication device 188 and receive location-based information from other mobile devices and/or Bluetooth™ enabled devices.

### Example Map View with Indication of Current Geographic Area

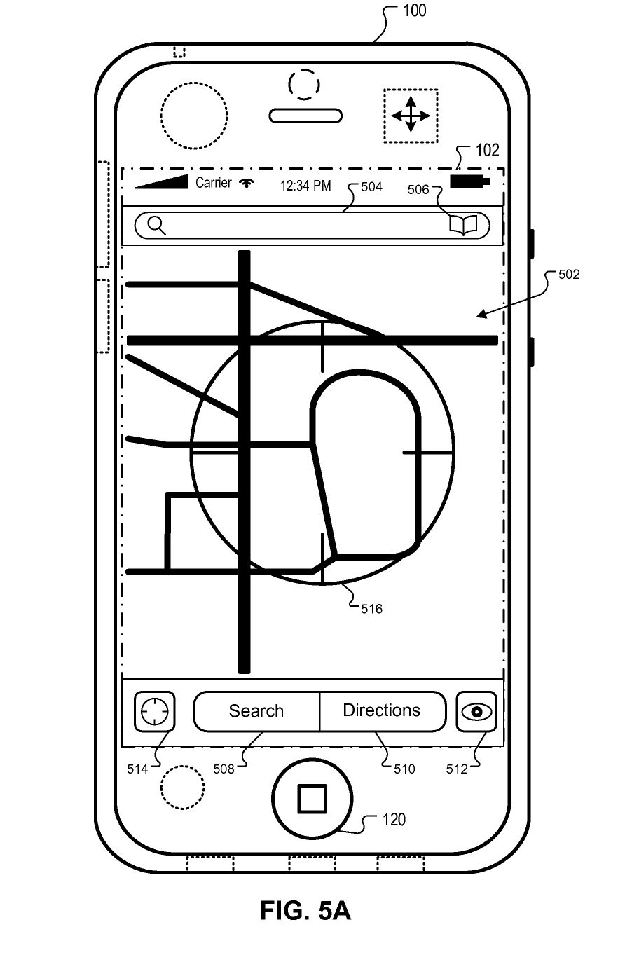

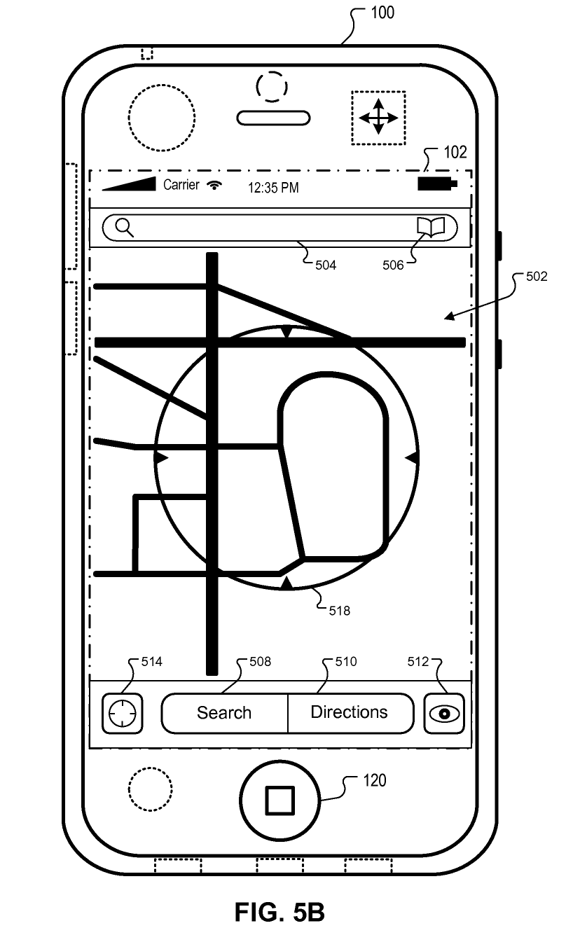

FIG. 5A illustrates an example of a map 502 with a geographic area displayed on mobile device 100. In some implementations, the mobile device 100 can display the map 502 on the touch sensitive display 102 of mobile device 100. The map 502 can be displayed when a user selects the maps object 144 to view mapping and location based services. In some implementations, objects, such as the maps object 144, can be selected by voice activation. A search bar 504 and a bookmarks list object 506 can be displayed at the top of the map 502. Below the bottom of the map one or more display objects can be displayed, for example a search object 508, a directions object 510, a map view object 512, and a current location object 514.

The search bar 504 can be used to find an address or other location on the map. For example, a user can enter their home address in the search bar 504, and the region containing the address would be displayed on the map 502. The bookmarks list object 506 can, for example, bring up a Bookmarks list which contains addresses that are frequently visited, such as a user's home address. The Bookmarks list can also, for example, contain special bookmarks such as the current location (e.g. the current location of the mobile device 100).

The search object 508 can be used to display the search bar 504 and other map related search menus. The directions object 510 can, for example, bring up a menu interface that allows the user to enter a start and end location. The interface can then display information (e.g., directions and travel time for a route from the start location to the end location). The map view object 512 can bring up a menu that will allow the user to select display options for the map 502. For example, the map 502 can be changed from black and white to color, the background of the map can be changed, or the user can change the brightness of the map.

The current location object 514 can allow the user to see a geographic area 516 on the map 502 indicating where the device 100 is currently located. A special current location bookmark can be placed in the Bookmarks list when the current location object 514 is selected. If the special current location bookmark was previously set in the Bookmarks list, the old bookmark information can, for example, be replaced with the new current location information. In some implementations, the special current location bookmark is tied to the centroid of the geographic area 516. That is, the special current location bookmark includes the coordinates for the centroid of the geographic area 516. The geographic area 516 can be based on location data determined or estimated using location-based services 408, 410, or 422, or some other location data, such as the data previously described in reference to FIG. 4. The geographic area 516 can, for example, be depicted by a circle, rectangle, square, or other enclosed region with crosshairs, or some other distinctive element to differentiate the geographic area 516 from the map 502.

In some implementations, the geographic area 516 indicates a region in which the mobile device 100 is determined or estimated to be located, and the geographic area may not necessarily be centered on the actual current position of the mobile device 100. In this example, the mobile device 100 may be located off-center within the geographic area. In another example, the geographic area 516 can be centered on an estimated current position of the mobile device 100.

The mobile device 100 can, for example, center the map view on the geographic area 516 when the current location object 514 is tapped or otherwise selected. In some implementations, the zoom level of the map can be adjusted based on the accuracy or precision of the location data or the technology, system, or service that provided the location data. For example, the map can be zoomed in for higher accuracy GPS location data and zoomed out for lower accuracy cell tower or Wi-Fi location data. In another implementation, the zoom level can be based on the velocity of the mobile device 100 (e.g., the map can be zoomed out at higher velocities and zoomed in when the mobile device 100 is not moving). A combination of accuracy or precision and velocity can also be used.

If all methods for retrieving location-based data fail (e.g., location-based service A 408, location-based service B 410, and location-based service C 422 fail), and there are no other systems or services available for determining or estimating the current position of the mobile device 100, an error can be displayed to the user and no geographic area is displayed on the map 502. The error can, for example, contain a message to the user informing them of the failure and the possible reason or reasons for the failure.

The current location object 514 can be selected, for example, to activate the estimating and displaying of geographic area 516 on the map 502, to get directions to or from the estimated current location (i.e., the centroid of the geographic area 516), to send the estimated current location of the mobile device 100 to a friend (e.g., such that the friend can go to the same location), or to create a bookmark for the estimated current location.

FIG. 5B illustrates another example of the map 502 with a geographic area 518 on the mobile device 100. In this example the geographic area 518 is shown as a circle with ticks on the perimeter of the circle. Other distinctive features could also be used to differentiate the geographic area 518 from the remainder of the map 502, such as a square, a triangle, or a shaded region. The perimeter of the geographic area 518 can, for example, have crosshairs, tick marks, shading, or some other feature to make it stand out from the map 502. In another example, the geographic area 518 can be shaded and/or highlighted, or the area of the map 502 outside of the geographic area 518 can be shaded and/or highlighted.

The circle outlining the geographic area 518 can, for example, have animation, or be motionless. The circle can, for example, change color (e.g. user defined colors or pre-programmed colors on the mobile device 100), change distinctive features (e.g. switch between crosshairs and ticks), or have moving distinctive features (e.g. the ticks changing position). The circle could, for example, have white space overlaid on top of the map directly around the perimeter, or some combination of features. In some implementations, the contrast of the circle's color can oscillate or pulse to differentiate the circle from the map 502.

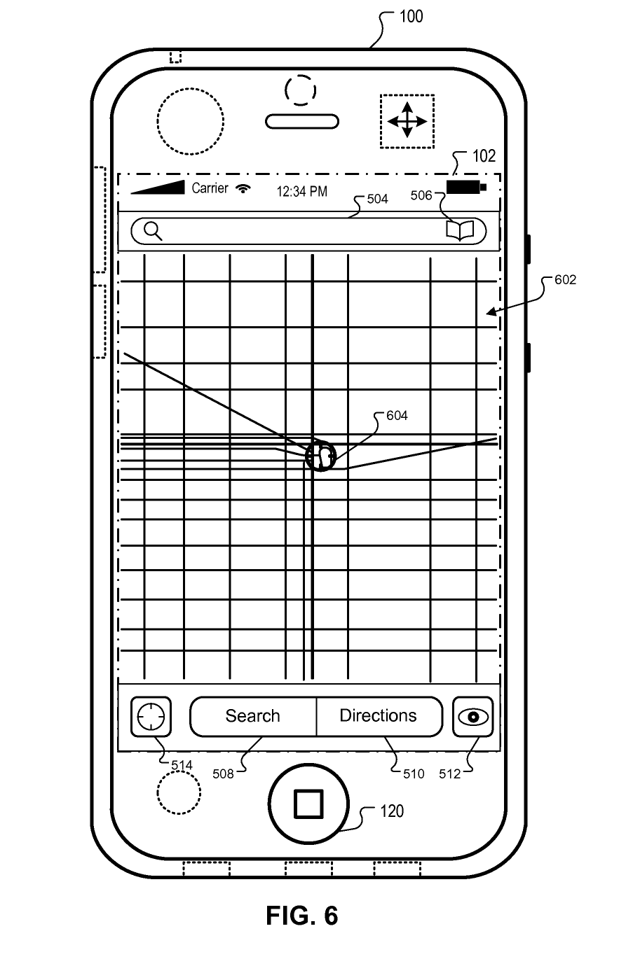

FIG. 6 illustrates a zoomed out view 602 of the map 502 from FIG. 5A. In this example the user is able to view a large area of the map 602 around a geographic area 604. The geographic area 604 can, for example, be the geographic area 516 rescaled to match the scale of the zoomed out view 602. The user can, for example, find restaurants, entertainment, or some other destination located in or in the vicinity of the geographic area 604. This view of the map 602 can be presented when the mobile device 100 is moving (e.g., when the user of the mobile device 100 is a passenger in a moving vehicle). In some implementations, the geographic area 604 can be determined or estimated when the current location object 514 is selected and does not change with the movement of the mobile device 100. In some other implementations, the geographic area 604 can move on the map 602 with the movement of the mobile device 100.

In some implementations, the geographic area 604 can be based on data from the most recent query to the Wi-Fi base station device 404. The geographic area 604 could also, for example, be based on historical data of where the mobile device 100 was most recently located. For example, if the geographic area 604 was last updated a short time before the newest activation, the previous location can be used to identify the new location. In some implementations, an error can be displayed on the mobile device 100 (e.g., if the previous current location showed that the user is in California, but a new location 30 minutes later shows a current location in Florida).

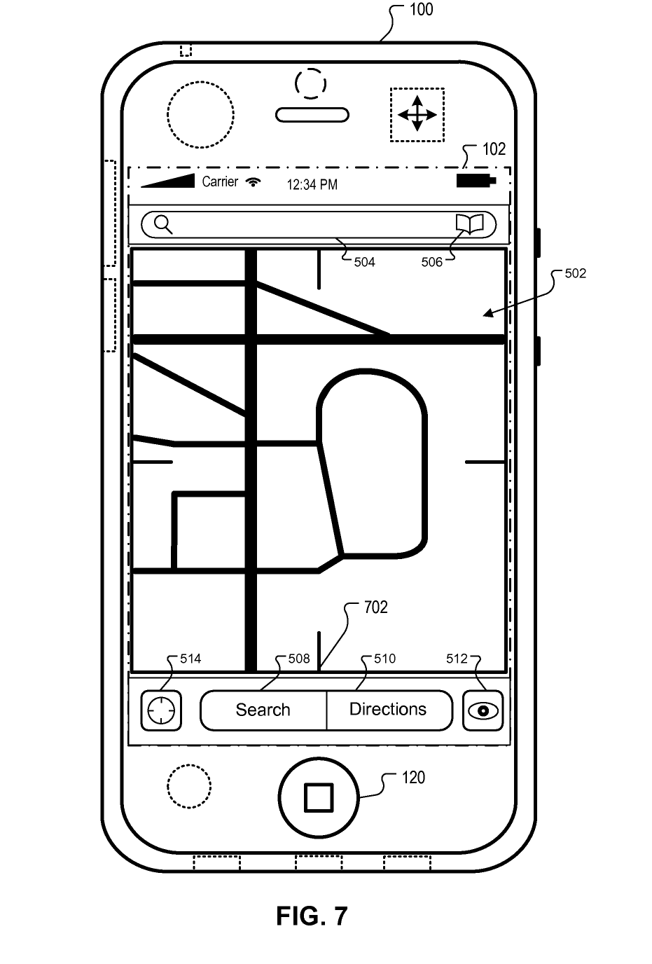

FIG. 7 illustrates another view of the map 502 from FIG. 5A. In this example, a geographic area 702 encloses the entire view of the map 502. In some implementations, this view of the map 502 and geographic area 702 can be shown, for example, when the mobile device is not moving or not moving very quickly (e.g., when the user with mobile device 100 is walking). The geographic area 702 can be displayed to contain the entire view of the map 502 when, at a given zoom level of the map 502, the accuracy or precision of the estimated position of the device 100 spans the entirety of the displayed area of the map 502 (i.e., the geographic area 702 covers the entirety of the displayed portion of the map 502 at the given zoom level). For example, if the map is zoomed to display a 50-meter region around the estimated current position and the accuracy of the estimated current position is 100 meters, then the geographic area 702 can be displayed to enclose the displayed region of the map.

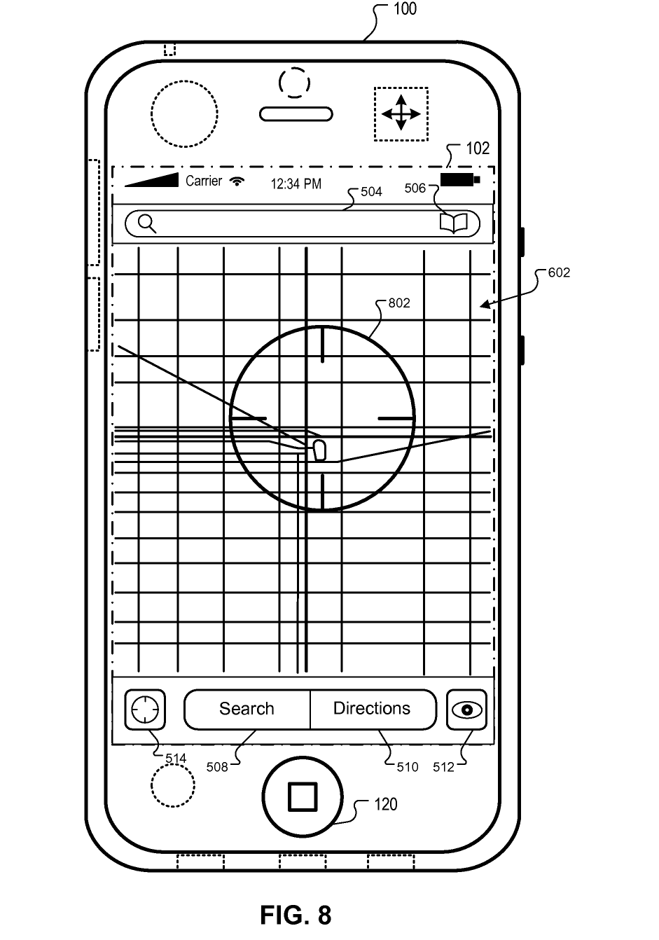

FIG. 8 illustrates another view of map 602 with a larger geographic area 802 than shown in FIG. 6 (e.g., geographic area 604). The geographic areas 604 and 802 can be determined using, Wi-Fi, such as through access point 404, cell communication using cell phone towers 406, or using multiple satellites 420, as described above in reference to FIG. 4. The differential between geographic areas 604 and 802 can be the result of using different positioning technologies (e.g., systems or services having varying levels of accuracy or precision, such as a GPS and a radio tower) to determine the specific geographic area.

In some implementations, the scaling of the map can be different based on the geographic area selected, the technology/system/service used to determine or estimate the geographic area, or some other requirement. For example, if the first geographic area, determined using access points 404, and is selected to be presented as the geographic area 516 in FIG. 5A, the scaling can be larger than if the second geographic area, determined using cell tower 406, was selected to be presented as geographic area 802 in FIG. 8. In some implementations, if the default zoom level determined to be used on the mobile device 100 is close to the currently used zoom level, the zoom level can remain unchanged. For example, if the default level is a street zoom and the current zoom level is a city view, then no change is made. If the current zoom level is a state view, and the default level is a street view, the map 602 can be changed to a street view.

In some implementations, the line width of the circle around the geographic area 802 can be changed based on the zoom level. In some implementations, the line width can stay the same. For example, the line width can get larger or smaller when zooming in closer to the map. The change to the line width and/or to lengths of the crosshairs, tick marks, or the like on the circle can be based on an exponential algorithm, a linear algorithm, or some other algorithm.

### Example Location Calculation

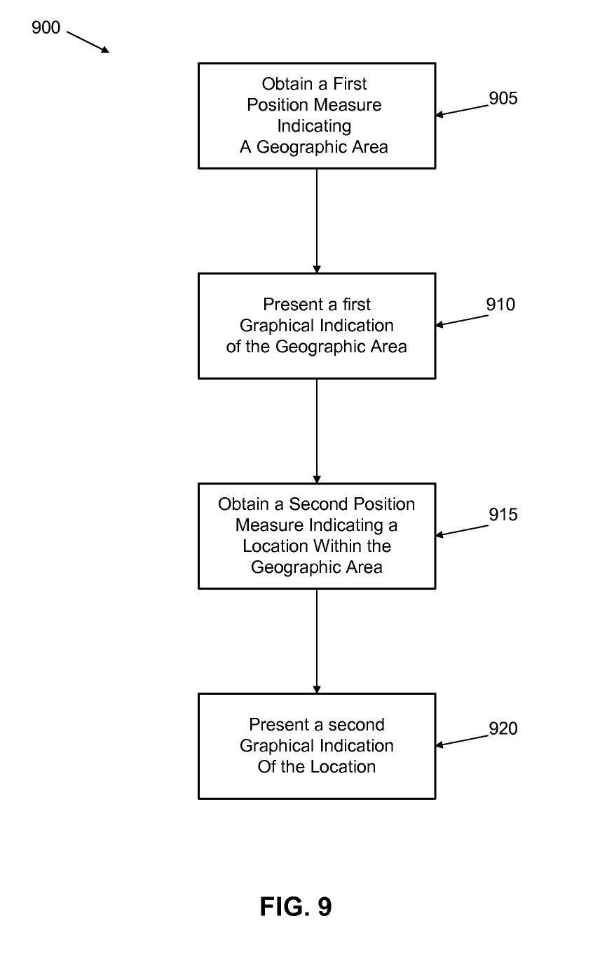

FIG. 9 illustrates a flow diagram of an example process 900 for indicating a location within a geographic area. In one implementation, a first position measure (e.g., a coarse position measure), can be obtained (e.g., received), 905 at the mobile device 100 using the methods described above. For example, the first position measure (e.g., obtained using access point 404, cell phone towers 406, or multiple satellites 420), can indicate a geographic area where the mobile device is generally located (e.g., an area). The first position measure can be presented 910 using a graphical indicator (e.g., representing the geographic area), on a user interface. The geographic area can be based on location data determined or estimated using location-based services 408, 410, or 422, or some other location data, such as the data previously described in reference to FIG. 4. Additionally, during the determination of the first position measure, or after the determination of the first position measure, a second position measure can be obtained 915 to determine a specific or more exact location within the geographic area.

As noted above, the geographic area can, for example, be depicted by a circle, rectangle, square, or any other enclosed region. The geographic area can include crosshairs, or some other distinctive element to differentiate the geographic area from the map. In implementations where the geographic area indicates a region in which the mobile device 100 is determined or estimated to be located, the geographic area may not necessarily be centered on the actual current position of the mobile device 100. For example, the mobile device 100 can be located off-center within the geographic area. In another example, the mobile device 100 can be located outside of the geographic area. In yet another example, the geographic area can be centered on an estimated current position of the mobile device 100. The steps described in FIG. 9 can be part of an iterative process.

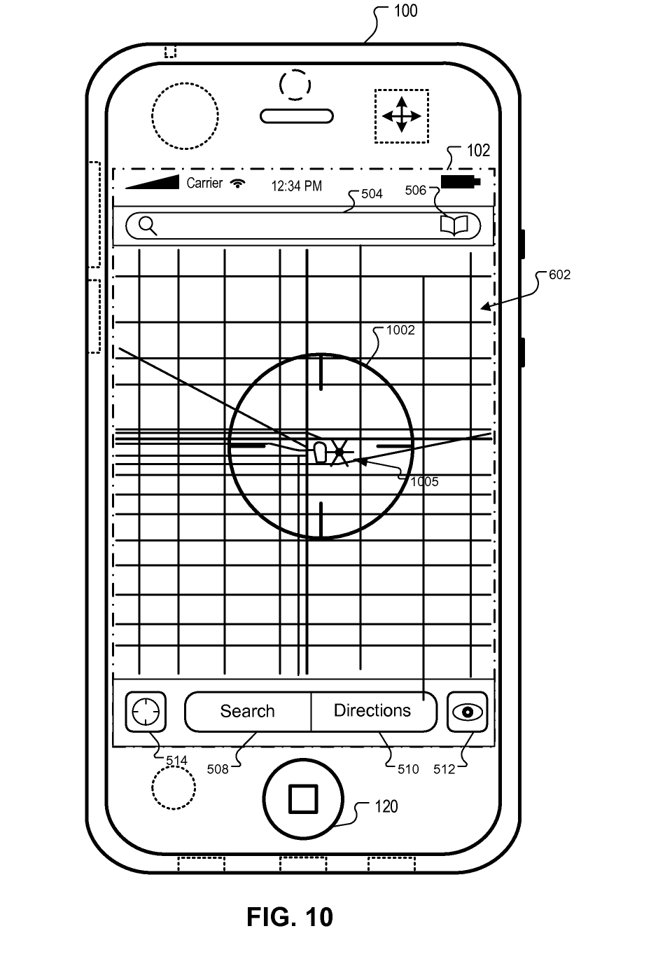

FIG. 10 illustrates another view of the map from FIG. 5A with a geographic area (e.g., geographic area 1002), including an animated location indicator. The geographic area 1002 includes a first graphical indicator 1005 signifying the performance of a determination (e.g., based on a second position measure), to obtain 915 a specific or more exact location within the geographic area 1002 (e.g., a location within the geographic area 1002 where the mobile device 100 is more accurately located).

The first graphical indicator 1005 is used when, for example, a first geographic area is determined by access point 404 or cell tower 406, and a second geographic area is determined by multiple satellites 420. Thus, for example, when a first geographic area has been determined and while the second geographic area is being determined, the first graphical indicator 1005 is displayed to the user. Additionally, after the second geographic location within the geographic area is determined 915, a second graphical indicator can be presented 920 to the user on the user interface. The second graphical indicator can represent a specific location within the geographic area 802. In some implementations, the second graphical indicator can be an updated first graphical indicator.

In some implementations, a graphical indicator 1005 is used when a first geographic area is determined by one or more access points 404, a second geographic area is being determined by one or more cell towers 406, and third geographic area is being determined by multiple satellites 420. In some implementations, a graphical indicator 1005 is used when a first geographic area is determined by one or more access points 404, a second geographic area is determined by one or more cell towers 406, and third geographic area is being determined by multiple satellites 420. Additionally, when the user of the mobile device 100 changes locations, the location determined to be the exact location of mobile device 100, and the graphical indicator 1005 representing the exact location of mobile device 100, can change accordingly.

Thus, while a determination is made defining a more precise geographic area representing the location of mobile device 100, the graphical indicator 1005 can be displayed (e.g., in a graphical interface), to the user. In some implementations, the graphical indicator 1005 can be animated (e.g., to indicate that the ‘better’ location is being determined). Examples of animations include but are not limited to pulses, color changes, swirling, swirling colors, pulsing swirling colors, starbursts, and other graphical indicators. In some implementations, the graphical indicator 1005 can include a center point (e.g., a dot square, triangle, rectangle, smiley face, swirled ball, or other graphical indicator) from which one or more animated lines radiate. In some implementations, the graphical indicator 1005 can include an audio element (e.g., informing the user that a determination is being made regarding the user's location). In some implementations, the graphical indicators can be omitted if location determination is not the focus of the user's activity (e.g., triggered by another user action).

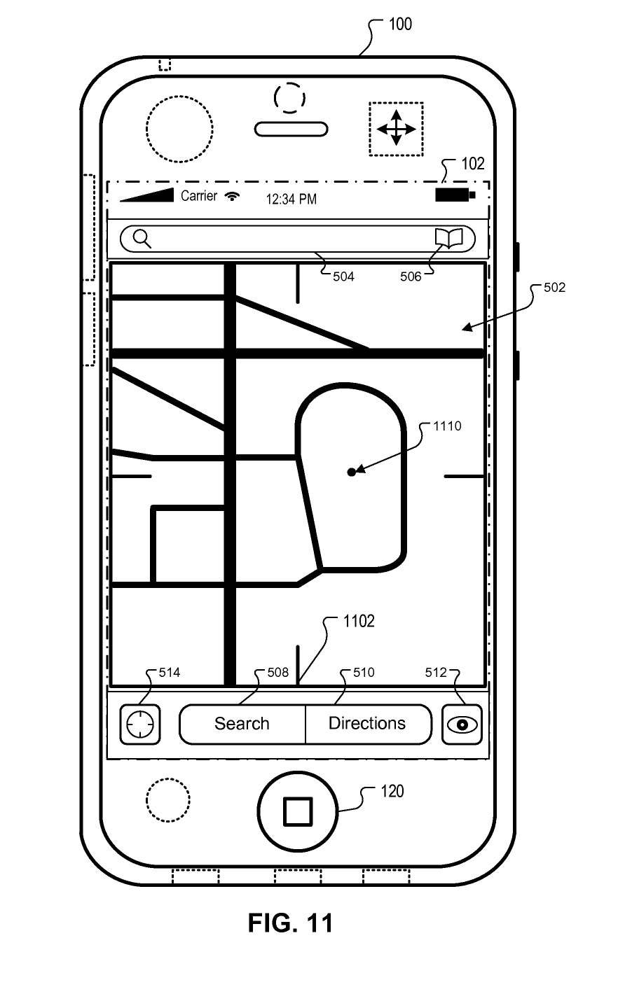

FIG. 11 illustrates another view of the map 502 (from FIG. 5A) with a geographic area including a non-animated location indicator (e.g., dot 1110). In this example, a geographic area 1102 encloses the entire view of the map 502 (e.g., as demonstrated above with respect to FIG. 7). In some implementations, once a relatively precise geographic location is determined for mobile device 100, a zoomed-in or magnified view 1102 of map 502 is presented to the user on the graphical interface. The zoomed-in view 1102 can include a particular portion of geographic area 1002, and thus the entire geographic area 1002 is not necessarily shown to the user in FIG. 11.

In some implementations, the user can indicate the amount of the map or geographic area that will be displayed when an exact or more specific location is determined. In some implementations, the amount of the map or geographic area that will be displayed is a default amount. In some implementations, the amount of the map or geographic area that will be displayed is determined as part of the calculation described above with respect to determining a location. In some implementations, the first geographical representation is small enough such that when the more precise geographic representation is determined, the view of the map does not change.

In some implementations, stopping the animation indicates that a more precise or exact geographic location for mobile device 100 has been determined. In some implementations, replacing the animated indicator (e.g., graphical indicator 1005) with a non-animated indicator (e.g., graphical indicator 1110), will signify that a more precise or exact geographic location for mobile device 100 has been determined. In some implementations, changes to a graphical indicator will also cause changes to a related audio element. For example, when a more precise or exact geographic location for mobile device 100 is determined, the animation can stop or be replaced by a non-animated indicator, and a related audio element can inform the user that a more precise or exact location has been obtained. In some implementations, force feedback (e.g., vibration) can also be provided by the mobile device 100 to indicate that a more precise or exact geographic location has been determined.

Though aspects of the method have been described with respect to a mobile device, it should be understood that any functionality described herein can be performed on any device or system attached to or incorporated within any mode of transportation.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
obtaining a first position measure at a mobile device, the first position measure indicating a geographic area where the mobile device is located;
presenting a first graphical indicator on a user interface, the first graphical indicator representing the geographic area;
obtaining a second position measure at the mobile device, the second position measure indicating a location associated with the mobile device, the location being within the geographic area; and
presenting a second graphical indicator on the user interface, the second graphical indicator representing the location within the geographic area.

2. The method of claim 1, where the first position measure is obtained using one or more positioning systems including a wireless network positioning system, a cell-tower positioning system, and a global positioning system.

3. The method of claim 1, where presenting the graphical indicator includes presenting an animation indicating that the location within the geographic area is being determined.

4. The method of claim 1, where presenting the updated graphical indicator includes replacing the graphical indicator of the geographic area with a magnified representation of the location within the geographic area.

5. The method of claim 1, where the first position measure is performed using one or more access points, and second position measure is performed using multiple satellites.

6. The method of claim 1, where the first position measure is performed using one or more cell towers, and second position measure is performed using multiple satellites.

7. The method of claim 1, where the geographic area indicates a location within a geographic area associated with an error of the first position measure.

8. The method of claim 1, where the graphical indicator is presented with respect to a map.

9. A computer-readable medium having instructions stored thereon, which, when executed by at least one processor, cause the processor to perform operations comprising:
obtaining a first position measure at a mobile device, the first position measure indicating a geographic area where the mobile device is located;
presenting a graphical indicator on a user interface, the graphical indicator representing the geographic area;
obtaining a second position measure at the mobile device, the second position measure indicating a location associated with the mobile device, the location being within the geographic area; and
presenting an updated graphical indicator on the user interface, the updated graphical indicator representing the location within the geographic area.

10. The computer-readable medium of claim 9, where the first position measure is obtained using one or more positioning systems including a wireless network positioning system, a cell-tower positioning system, and a global positioning system.

11. The computer-readable medium of claim 9, where presenting the graphical indicator includes presenting an animation indicating that the location within the geographic area is being determined.

12. The computer-readable medium of claim 9, where presenting the updated graphical indicator includes replacing the graphical indicator of the geographic area with a magnified representation of the location within the geographic area.

13. The computer-readable medium of claim 9, where the first position measure is performed using one or more access points, and second position measure is performed using multiple satellites.

14. The computer-readable medium of claim 9, where the first position measure is performed using one or more cell towers, and second position measure is performed using multiple satellites.

15. The computer-readable medium of claim 9, where the geographic area indicates a location within a geographic area associated with an error of the first position measure.

16. The computer-readable medium of claim 9, where the graphical indicator is presented with respect to a map.

17. A system comprising:
one or more processors;
memory coupled to the one or more processors and operable for storing instructions, which, when executed by the one or more processors, causes the one or more processors to perform operations, comprising:
obtaining a first position measure at a mobile device, the first position measure indicating a geographic area where the mobile device is located;
presenting a graphical indicator on a user interface, the graphical indicator representing the geographic area;
obtaining a second position measure at the mobile device, the second position measure indicating a location associated with the mobile device, the location being within the geographic area; and
presenting an updated graphical indicator on the user interface, the updated graphical indicator representing the location within the geographic area.

18. The system of claim 17, where the first position measure is obtained using one or more positioning systems including a wireless network positioning system, a cell-tower positioning system, and a global positioning system.

19. The system of claim 17, where presenting the graphical indicator includes presenting an animation indicating that the location within the geographic area is being determined.

20. The method of claim 17, where presenting the updated graphical indicator includes replacing the graphical indicator of the geographic area with a magnified representation of the location within the geographic area.
